(19) United States
(12) Patent Application Publication
(10) Pub. No.: US 2013/0046467 A1
(43) Pub. Date: Feb. 21, 2013

(54) METHOD AND APPARATUS FOR DETERMINING TRAVELING ROUTE

(71) Applicants: Hidenao Iwane, Kawasaki (JP); Kazuhiro Matsumoto, Kawasaki (JP)

(72) Inventors: Hidenao Iwane, Kawasaki (JP); Kazuhiro Matsumoto, Kawasaki (JP)

(73) Assignee: FUJITSU LIMITED, Kawasaki-shi (JP)

(21) Appl. No.: 13/585,870

(22) Filed: Aug. 15, 2012

(30) Foreign Application Priority Data
Aug. 19, 2011 (JP) 2011-179546

(51) Int. Cl. G01C 21/00

(52) U.S. Cl. 701/540

(57) ABSTRACT

The disclosed method includes: first identifying, for each candidate place of a second place that will be traveled subsequently to a first place whose traveling order has been determined among plural places and for which traveling order is not determined, a point in a space mapped by a travel cost and one or plural costs, by reading out a travel cost value between the first place and the candidate place, and reading one or plural cost values of the candidate place from a second data storage unit; extracting one or plural candidate places corresponding to Pareto solutions in the space; second identifying the second place from the one or plural extracted candidate places; and generating traveling route candidates for the plural places by repeating the first identifying, the extracting and the second identifying.

### CROSS-REFERENCE TO RELATED APPLICATIONS

This application is based upon and claims the benefit of priority of the prior Japanese Patent Application No. 2011-179546, filed on Aug. 19, 2011, the entire contents of which are incorporated herein by reference.

### FIELD

This technique relates to a technique for determining a traveling route.

### BACKGROUND

The traveling salesman problem is a problem that n cities (also called “work place” or “work point”) and distances between cities are inputted to obtain a traveling route whose total travel distance is minimum among traveling routes to return the start point after each city is visited once. This problem is known as the NP-hard problem, and is a representative problem that is assumed to be difficult among combinational optimization problems. However, because there are a lot of applications such as delivery planning, board drilling, rolling planning of steel plates, it is preferable to process such a problem by any method in short time.

Conventional methods for determining a traveling route include a method for accurately solving the traveling route by the round-robin method, dynamic programming or the like. However, because the number of traveling route candidates increases exponentially with respect to the number of cities, there is a case where the processing does not complete within a practical time. In addition, as a method for obtaining a solution almost corresponding to the optimal solution, there is a method such as the nearest neighbor method. However, there is no guarantee to obtain a solution with sufficient accuracy.

In the nearest neighbor method, a traveling route is created by starting from any appropriate point, moving to the nearest point among points that have not been visited yet, from the present place, and returning to the start point after all points were visited.

Incidentally, there is a method using an initial Pareto search unit to search for initial Pareto solutions by a method for calculating the initial solutions rapidly and a Pareto solution set search unit to search for a Pareto optimal solution set by using the searched initial Pareto solutions by using a genetic algorithm. However, this method does not take into consideration the traveling salesman problem.

### SUMMARY

An information processing method relating to this technique includes: (A) first identifying, for each candidate place of a second place that will be traveled subsequently to a first place whose traveling order has been determined among a plurality of places and for which traveling order is not determined among the plurality of places, a point in a space mapped by a travel cost and one or plural costs, by reading out a travel cost value between the first place and the candidate place from a first storage unit storing a travel cost value for each combination of two places among the plurality of places, and reading one or plural cost values of the candidate place from a second data storage unit storing one or plural cost values for each of the plurality of places; (B) extracting one or plural candidate places corresponding to Pareto solutions in the space; (C) second identifying the second place from the one or plural extracted candidate places; and (D) generating traveling route candidates for the plurality of places by repeating the first identifying, the extracting and the second identifying.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a functional block diagram of an information processing apparatus relating to a first embodiment;

FIG. 2 is a diagram depicting an example of data stored in a first data storage unit;

FIG. 3 is a diagram depicting an example of data stored in a second data storage unit;

FIG. 4 is a diagram depicting a processing flow relating to the first embodiment;

FIG. 5A is a diagram to explain a processing in the first embodiment;

FIG. 5B is a diagram to explain a processing in the first embodiment;

FIG. 5C is a diagram to explain a processing in the first embodiment;

FIG. 5D is a diagram to explain a processing in the first embodiment;

FIG. 5E is a diagram to explain a processing in the first embodiment;

FIG. 5F is a diagram to explain a processing in the first embodiment;

FIG. 5G is a diagram to explain a processing in the first embodiment;

FIG. 5H is a diagram to explain a processing in the first embodiment;

FIG. 5I is a diagram to explain a processing in the first embodiment;

FIG. 6A is a diagram to explain a processing to identify a Pareto optimal solution on a plane mapped by a travel cost and a second cost;

FIG. 6B is a diagram to explain a processing to identify the Pareto optimal solution on the plane mapped by the travel cost and the second cost;

FIG. 6C is a diagram to explain a processing to identify the Pareto optimal solution on the plane mapped by the travel cost and the second cost;

FIG. 7 is a diagram depicting a processing flow in the first embodiment;

FIG. 8 is a functional block diagram of an information processing apparatus relating to a second embodiment;

FIG. 9 is a diagram depicting a processing flow relating to the second embodiment;

FIG. 10A is a diagram depicting a processing in the second embodiment;

FIG. 10B is a diagram depicting a processing in the second embodiment;

FIG. 10C is a diagram depicting a processing in the second embodiment;

FIG. 10D is a diagram depicting a processing in the second embodiment;

FIG. 10E is a diagram depicting a processing in the second embodiment;

FIG. 10F is a diagram depicting a processing in the second embodiment;

FIG. 10G is a diagram depicting a processing in the second embodiment;

FIG. 10H is a diagram depicting a processing in the second embodiment;

FIG. 10I is a diagram depicting a processing in the second embodiment;

FIG. 11 is a diagram depicting a processing flow relating to the second embodiment; and

FIG. 12 is a functional block diagram of a computer.

### DESCRIPTION OF EMBODIMENTS

### Embodiment 1

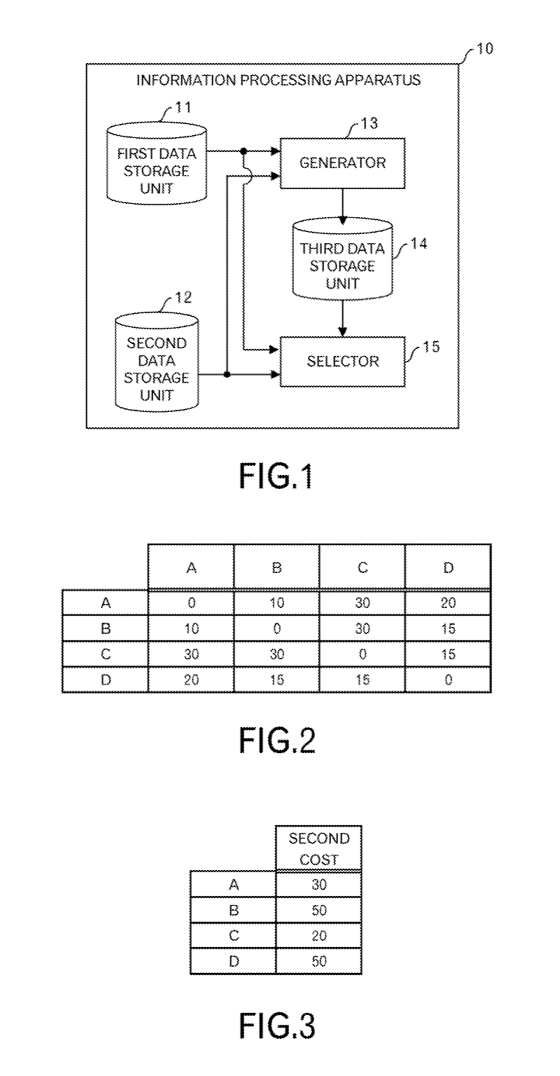

FIG. 1 illustrates an information processing apparatus 10 relating to a first embodiment of this technique. The information processing apparatus 10 relating to this embodiment has a first data storage unit 11, a second data storage unit 12, a generator 13, a third data storage unit 14 and a selector 15. The first data storage unit 11 stores data of travel costs (e.g. distance, travel time, or the like) for each combination of two places among plural places to be traveled. The second data storage unit 12 stores one or plural cost values predetermined for each place among the plural places to be traveled, and a value used for evaluation for each place among the plural places to be traveled.

The generator 13 generates traveling route candidates by using data stored in the first data storage unit 11 and the second data storage unit 12, and stores data of the generated traveling route candidates into the third data storage unit 14. The selector 15 uses the data stored in the first data storage unit 11 and the second data storage unit 12 to evaluate the traveling route candidates, identifies an appropriate traveling route, and outputs the identified traveling route.

Next, processing contents of the information processing apparatus 10 will be explained by using FIGS. 2 to 7. In order to make it easy to understand the explanation, a case is considered where the traveling is carried out among places A to D. FIG. 2 illustrates an example of data of the travel costs stored in the first data storage unit 11. More specifically, the travel cost value (e.g. travel time) is registered for each combination of two places among the places A to D. In this example, the travel cost value from the place A to the place B is the same as the travel cost value from the place B to the place A. However, they may be different. Moreover, FIG. 3 illustrates an example of data of the cost values stored in the second data storage unit 12. More specifically, a second cost (e.g. importance degree for the disaster recovery or the like (the importance degree is higher, when its value is lesser.)) for each of the places A to D. In this example, in order to make the explanation simple, one kind of cost is handled. However, plural kinds of costs may be handled.

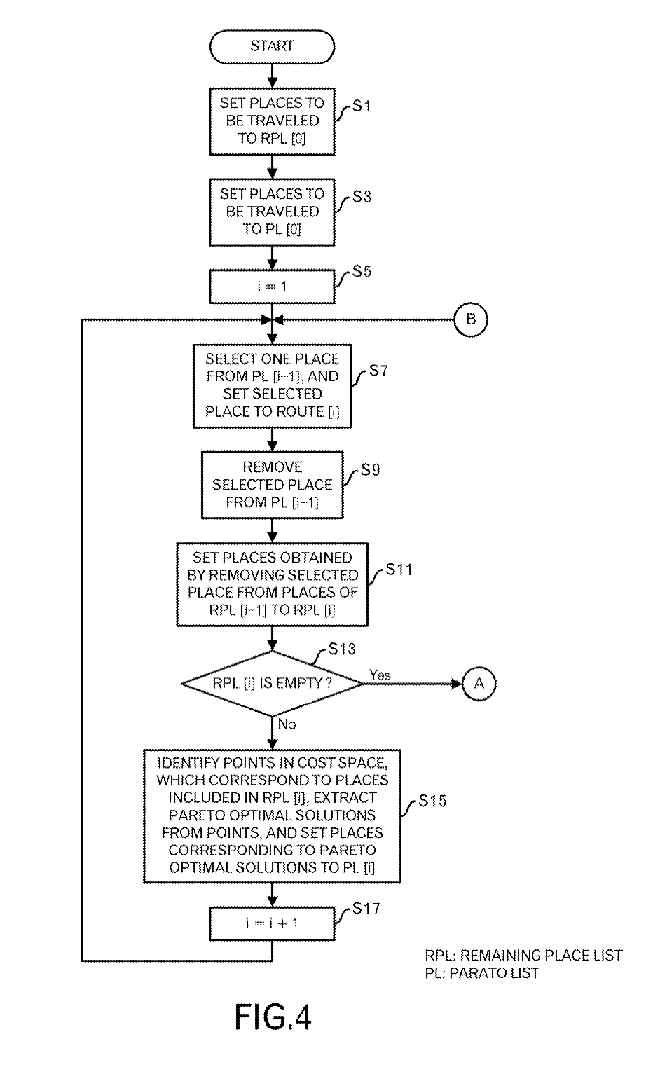

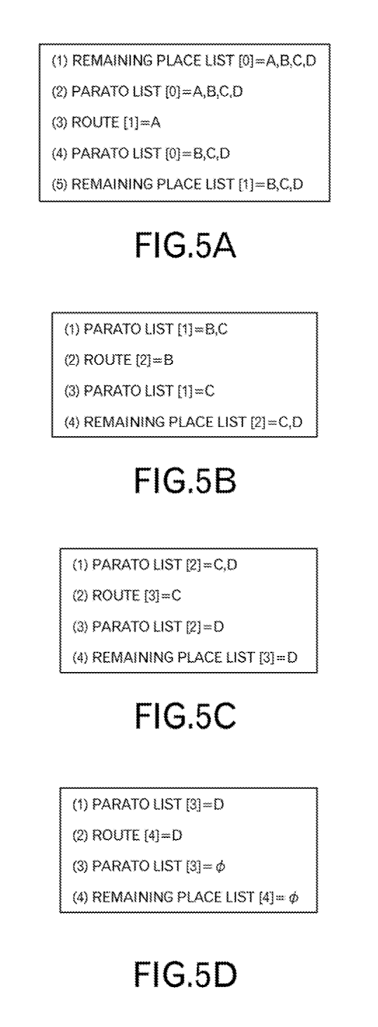

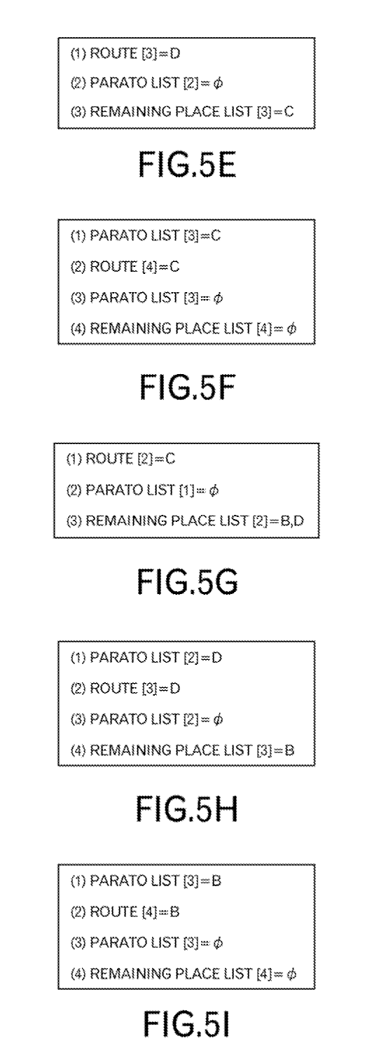

Next, a processing flow in FIGS. 4 to 7 will be explained. The generator 13 sets traveling places registered in the first data storage unit 11 and the second data storage unit 12 to a remaining place list [0], which is an array (step S1). In the aforementioned example, as illustrated in (1) of FIG. 5A, the remaining place list [0]=A, B, C and D. Moreover, the generator 13 sets the traveling places registered in the first data storage unit 11 and the second data storage unit 12 to a Pareto list [0], which is an array (step S3). As illustrated in (2) of FIG. 5A, the Pareto list [0]=A, B, C and D. Incidentally, when the start point has been determined among the traveling places, the start point is set to the Pareto list [0]. Then, the generator 13 initializes a counter i to “1” (step S5).

After that, the generator 13 selects one place from the Pareto list [i−1], and sets the selected place to a route [i], which is an array (step S7). The selection of this step may be carried out by any method. For example, the place A is selected from the Pareto list [0], and the route [1]=A is set as illustrated in (3) of FIG. 5A. Then, the generator 13 eliminates the selected place from the Pareto list [i−1] (step S9). When the place A is selected, the place A is eliminated. Therefore, as illustrated in (4) of FIG. 5A, the Pareto list [0]=B, C and D.

Furthermore, the generator 13 sets a place set generated by eliminating the selected place from the remaining place list [i−1], to the remaining place list [i] (step S11). When the place A is selected, the remaining place list [1]=B, C and D is set by eliminating the place A from the remaining place list [0]=A, B, C and D as illustrated in (5) of FIG. 5A. Then, the generator 13 determines whether or not the remaining place list [i] is empty (step S13). When the remaining place list [i] is empty, the processing shifts to a processing in FIG. 7 through a terminal A.

On the other hand, when the remaining place list [i] is not empty, the generator 13 identifies points in a cost space, which respectively correspond to places included in the remaining place list [i], extracts Pareto optimum solutions from among these points, and sets the places corresponding to the extracted Pareto optimum solutions to the Pareto list [i] (step S15).

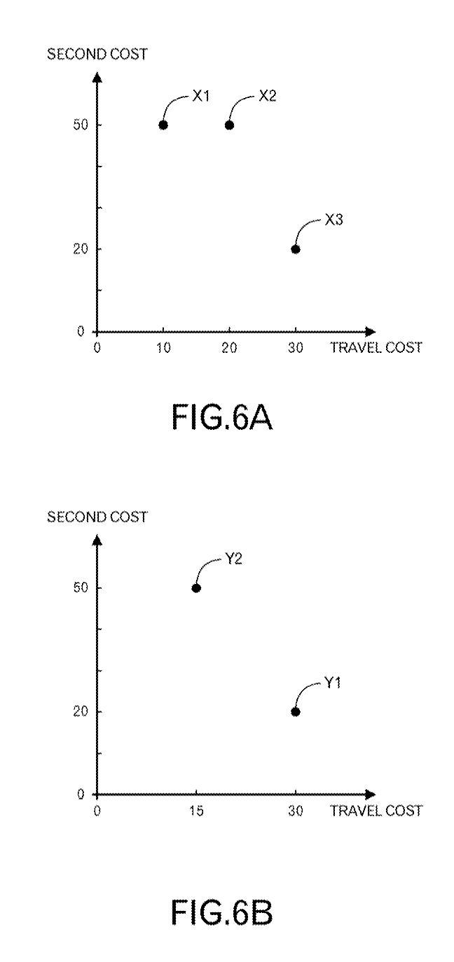

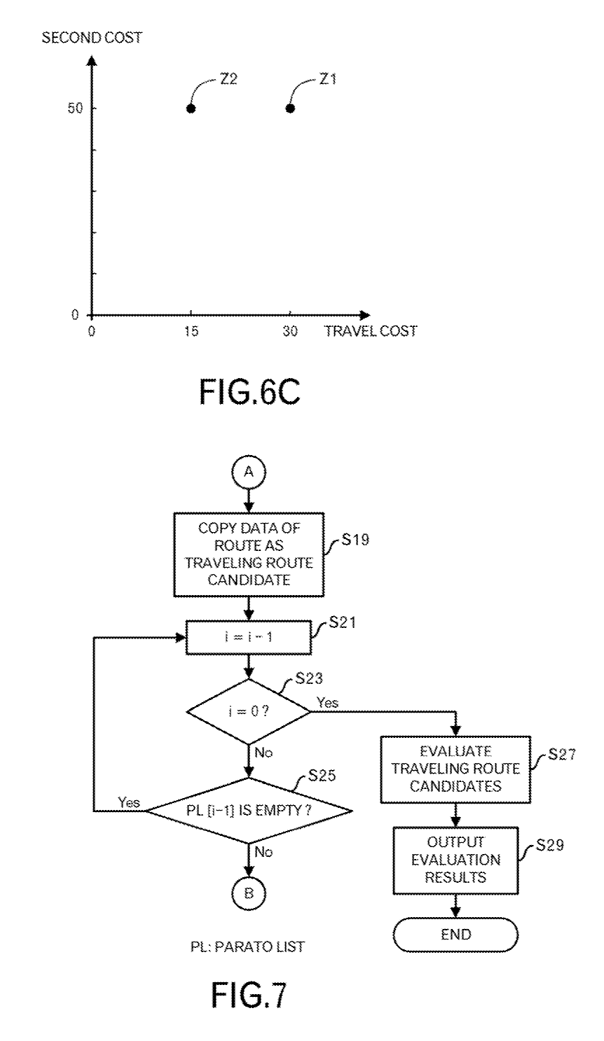

In a state of (5) in FIG. 5A, the remaining place list [1]=B, C and D, and points on a plane (generally, a space) mapped by the travel cost and the second cost are identified. Specifically, when the travel cost value=10 (FIG. 2) from the place A, which has been identified as being included in the route, to the place B, and the second cost value=50 (FIG. 3) of the place B are read out from the first data storage unit 11 and the second data storage unit 12, a point X1 on the plane illustrated in FIG. 6A is identified. Similarly, when the travel cost value=30 (FIG. 2) from the place A to the place C and the second cost value=20 (FIG. 3) of the place C are read out from the first data storage unit 11 and the second data storage unit 12, a point X3 on the plane illustrated in FIG. 6A is identified. Furthermore, when the travel cost value=20 (FIG. 2) from the place A to the place D and the second cost value=50 (FIG. 3) of the place D are read out from the first data storage unit 11 and the second data storage unit 12, a point X2 on the plane illustrated in FIG. 6A is identified. The Pareto optimal solution is a non-inferior (or non-dominated) solution in the cost space. In case of FIG. 6A, because the point X2 whose second cost value is the same but the travel cost is greater is apparently inferior to the point X1, the point X2 is not Pareto optimal solution. On the other hand, because the second cost is less and the travel cost is greater, it cannot be said that the point X3 is inferior to the point X1. As for the reverse relationship, it cannot be said that the point X1 is inferior to the point X3. Therefore, the points X3 and X1 are Pareto optimal solutions. Accordingly, the place C corresponding to the point X3 and place B corresponding to the point X1 are extracted, and as illustrated in (1) of FIG. 5B, they are set to the Pareto list [1].

After that, the generator 13 increments i by “1” (step S17), and the processing returns to the step S7.

In the aforementioned example, the place B is selected from the Pareto list [1], and as illustrated in (2) of FIG. 5B, route [2]=B is set (step S7). Furthermore, when the selected place B is removed from the Pareto list [1] (step S9), as illustrated in (3) of FIG. 5B, the Pareto list [1]=C is obtained. Furthermore, elements obtained by removing the selected place B from the remaining place list [1] are set to the remaining place list [2] (step S11). In other words, as illustrated in (4) of FIG. 5B, the remaining place list [2]=C and D is obtained.

Thus, because the remaining place list [2] is not empty, points in the cost space, which correspond to the places C and D included in the remaining place list [2], are identified to extract the Pareto optimal solutions from those points (step S15).

In a state of (4) in FIG. 5B, the remaining place list [2]=C and D. Therefore, points on the plane mapped by the travel cost and the second cost are identified. Specifically, a point Y1 on the plane illustrated in FIG. 6B is identified from the travel cost value=30 (FIG. 2) from the place B, which has been identified as being included in the route, to the place C and the second cost value of the place C=20 (FIG. 3). Moreover, a point Y2 on the plane illustrated in FIG. 6B is identified from the travel cost value=15 (FIG. 2) from the place B to the place D and the second cost value=50 (FIG. 3) of the place D. Because it cannot be said that either of the points Y1 and Y2 is superior, they are Pareto optimal solutions. Therefore, the place C corresponding to the point Y1 and the place D corresponding to the Y2 are extracted, and are set to the Pareto list [2] as illustrated in (1) of FIG. 5C. Here, i is incremented by “1” (step S17), and i=3 is obtained.

Then, the place C is selected from the Pareto list [2], and as illustrated in (2) of FIG. 5C, the route [3]=C is set (step S7). Furthermore, when the selected place C is removed from the Pareto list [2] (step S9), as illustrated in (3) of FIG. 5C, the Pareto list [2]=D is obtained. Moreover, elements obtained by removing the selected place C from the remaining place list [2] are set to the remaining place list [3]. In other words, as illustrated in (4) of FIG. 5C, the remaining point list [3]=D is obtained.

Thus, because the remaining place list [3] is not empty, a point in the cost space, which corresponds to the place D included in the remaining place list [3], is identified, and the Pareto optimal solution is extracted from the points (step S15). However, when only one place is included in the remaining place list [3], the place is designated as the Pareto optimal solution as it is. Namely, as illustrated in (1) of FIG. 5D, the Pareto list [3]=D is obtained. Here, i is incremented by “1” (step S17), i=4 is obtained.

Then, the place D is selected from the Pareto list [3], and as illustrated in (2) of FIG. 5D, the route [4]=D is set (step S7). Furthermore, when the selected place D is removed from the Pareto list [3] (step S9), the Pareto list [3]=φ is obtained as illustrated in (3) of FIG. 5D. Furthermore, elements obtained by removing the selected place D from the remaining place list [3] are set to the remaining place list [4] (step S11). In other words, as illustrated in (4) of FIG. 5D, the remaining place list [4]=φ is obtained. By carrying out such a processing, because the remaining place list [4] becomes empty, the processing shifts to a processing in FIG. 7 through the terminal A.

In FIG. 7, the generator 13 copies data of the route as a traveling route candidate, and stores the copied data into the third data storage unit 14 (step S19). One traveling route candidate has been generated with this processing. In the aforementioned example, a traveling route candidate including A, B, C and D in this order is stored in the third data storage unit 14. The following processing is a processing to search for other traveling route candidates.

Then, the generator 13 decrements i by “1” (step S21), and determines whether or not i becomes “0” (step S23). When i is not “0”, the generator 13 determines whether or not the Pareto list [i−1] is empty (step S25). When the Pareto list [i−1] is empty, the processing returns to the step S21. On the other hand, when the Pareto list [i−1] is not empty, the processing returns to the step S7 in FIG. 4 through the terminal B.

In the aforementioned example, in case of i=3, the Pareto list [2]=D is obtained in (3) of FIG. 5C. Therefore, the processing returns to the step S7 in FIG. 4.

Then, the place D is selected from the Pareto list [2], and as illustrated in (1) of FIG. 5E, the route [3]=D is set (step S7). Furthermore, when the selected place D is removed from the Pareto list [2] (step S9), the Pareto list [2]=φ is obtained as illustrated in (2) of FIG. 5E. Moreover, elements obtained by removing the selected place D from the remaining place list [2] ((4) in FIG. 5B) is set to the remaining place list [3] (step S11). In other words, as illustrated in (3) of FIG. 5E, the remaining place list [3]=C is obtained.

Because the remaining place list [3] is not empty as described above, a point in the cost space, which correspond to the place C included in the remaining place list [3], is identified, and the Pareto optimal solution is extracted from the point (step S15). However, when only one place is included in the remaining place list [3], the place is designated as the Pareto optimal solution as it is. Namely, as illustrated in (1) of FIG. 5F, the Pareto list [3]=C is obtained. Here, i is incremented by “1” (step S17), i=4 is obtained.

Then, the place C is selected from the Pareto list [3], and as illustrated in (2) of FIG. 5F, the route [4]=C is set (step S7). Furthermore, when the selected place C is removed from the Pareto list [3] (step S9), the Pareto list [3]=φ is obtained as illustrated in (3) of FIG. 5F. Moreover, elements obtained by removing the selected place C from the remaining place list [3] are set to the remaining place list [4] (step S11). In other words, as illustrated in (4) of FIG. 5F, the remaining place list [4]=φ is obtained. Because the remaining place list [4] becomes empty when carrying out such a processing, the processing shifts to the processing in FIG. 7 through the terminal A.

Then, at the step S19 in FIG. 7, the second traveling route candidate including A, B, D and C in this order is stored in the third data storage unit 14.

After that, in case of i=3, the Pareto list [2]=φ is obtained in (2) of FIG. 5E. Therefore, i is decremented by “1” (step S21). In case of i=2, as illustrated in (3) of FIG. 5B, the Pareto list [1]=C is obtained. Then, the processing returns to the step S7 in FIG. 4.

Then, the place C is selected from the Pareto list [1], and as illustrated in (1) of FIG. 5G, the route [2]=C is set (step S7). Furthermore, when the selected place C is removed from the Pareto list [1] (step S9), the Pareto list [1]=φ is obtained as illustrated in (2) of FIG. 5G. Moreover, elements obtained by removing the selected place C from the remaining place list [1] ((5) in FIG. 5A) is set to the remaining place list [2] (step S11). In other words, as illustrated in (3) of FIG. 5G, the remaining place list [2]=B and D is obtained.

Thus, because the remaining place list [2] is not empty, points in the cost space, which correspond to the place B and D included in the remaining place list [2], and the Pareto optimal solutions are extracted from these points (step S15).

In a state of (3) in FIG. 5G, the remaining place list [2]=B and D. Then, points on the plane mapped by the travel cost and the second cost are identified. Specifically, when the travel cost value=30 (FIG. 2) from the place C, which has been identified as being included in the route, to the place B, and the second cost value=50 (FIG. 3) of the place B are readout from the first data storage unit 11 and the second data storage unit 12, a point Z1 on the plane illustrated in FIG. 6C is identified. In addition, when the travel cost value=15 (FIG. 2) from the place C to the place D and the second cost value=50 (FIG. 3) of the place D are read out from the first data storage unit 11 and the second data storage unit 12, a point Z2 on the plane illustrated in FIG. 6C is identified. Because the travel cost value of the point D is less, the point D is the Pareto optimal solution. Therefore, the place D corresponding to the point Z2 is extracted, and as illustrated in (1) of FIG. 5H, the place D is set to the Pareto list [2]. Here, i is incremented by “1” (step S17), i=3 is obtained.

Then, the place D is selected from the Pareto list [2], and as illustrated in (2) of FIG. 5H, the route [3]=D is set (step S7). Furthermore, when the selected place D is removed from the Pareto list [2] (step S9), the Pareto list [2]=φ is obtained as illustrated in (3) of FIG. 5H. Moreover, elements obtained by removing the selected place D from the remaining place list [2] ((3) in FIG. 5G) are set to the remaining place list [3] (step S11). In other words, as illustrated in (3) of FIG. 5H, the remaining place list [3]=B is obtained.

Because the remaining place list [3] is not empty, a point in the cost space, which corresponds to the place B included in the remaining place list [3], is identified, and the Pareto optimal solution is extracted from the points (step S15). However, when only one place is included in the remaining place list [3], the place is designated as the Pareto optimal solution. Namely, as illustrated in (1) of FIG. 5I, the Pareto list [3]=B is obtained. Here, i is incremented by “1” (step S17), and i=4 is obtained.

Then, the place B is selected from the Pareto list [3], and as illustrated in (2) of FIG. 5I, the route [4]=B is set (step S7). Furthermore, when the selected place B is removed from the Pareto list [3] (step S9), the Pareto list [3]=φ is obtained as illustrated in (3) of FIG. 5I. Furthermore, elements obtained by removing the selected place B from the remaining place list [3] are set to the remaining place list [4] (step S11). Namely, as illustrated in (4) of FIG. 5I, the remaining place list [4]=T is obtained. By carrying out such a processing, the remaining place list [4] becomes empty. Therefore, the processing shifts to the processing of FIG. 7 through the terminal A.

Then, at the step S19 in FIG. 7, the third traveling route candidate including A, C, D and B in this order is stored in the third data storage unit 14. The Pareto list [1] becomes empty with this processing. Incidentally, B, C and D have been set to the Pareto list [0]. Therefore, a processing to exchange the start point is carried out. When the start point A is fixed, the generation of the traveling route is completed.

Returning to the explanation of the processing in FIG. 7, the selector 15 evaluates the traveling route candidates stored in the third data storage unit 14, and identifies the traveling route candidate whose evaluation value is the greatest (step S27). For example, the travel cost values stored in the first data storage unit 11 and other values (e.g. priority degree or the like) of the respective places, which are stored in the second data storage unit 12, are combined to calculate an evaluation value for each traveling route candidate.

After that, the selector 15 outputs the evaluation result to a display device or other computers (step S29). The traveling route candidates may be outputted as they are.

By carrying out such a processing, the processing to trace the Pareto optimal solutions is carried out. Therefore, it becomes possible to obtain the traveling route candidates including the traveling route identified by at least nearest neighbor method.

However, because the Pareto optimal solutions are traced, it becomes possible to obtain the traveling route candidates better than the route identified by the nearest neighbor method. Moreover, because the destination place is narrowed by the Pareto optimal solutions, the processing speed becomes faster than the round-robin method or the like.

### Embodiment 2

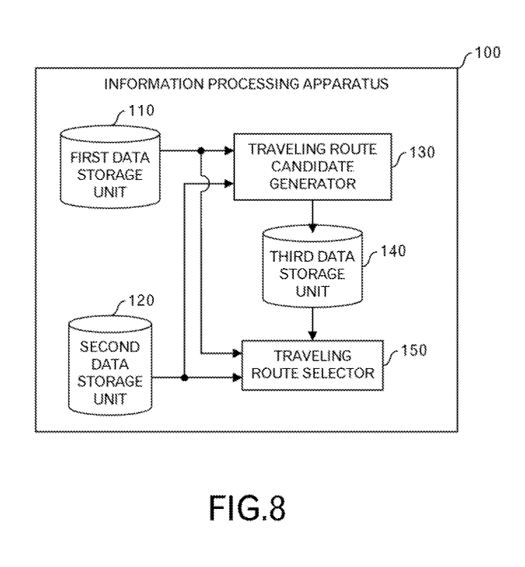

FIG. 8 illustrates a functional block diagram of an information processing apparatus 100 relating to the second embodiment.

The information processing apparatus 100 relating to this embodiment has a first data storage unit 110, a second data storage unit 120, a traveling route candidate generator 130, a third data storage unit 140, and a traveling route selector 150. The first data storage unit 110 stores data of the traveling cost (e.g. distance, traveling time or the like) for each combination of two places among plural places to be traveled. The second data storage unit 120 stores values of one or plural costs predetermined for each of plural places to be traveled and values used for evaluation for each of plural places to be traveled.

The traveling route candidate generator 130 generates traveling route candidates by using data stored in the first data storage unit 110 and the second data storage unit 120, and stores the generated traveling route candidates into the third data storage unit 140. The traveling route selector 150 evaluates the traveling route candidates by using data stored in the first data storage unit 110 and the second data storage unit 120, identifies an appropriate traveling route, and outputs the identified traveling route.

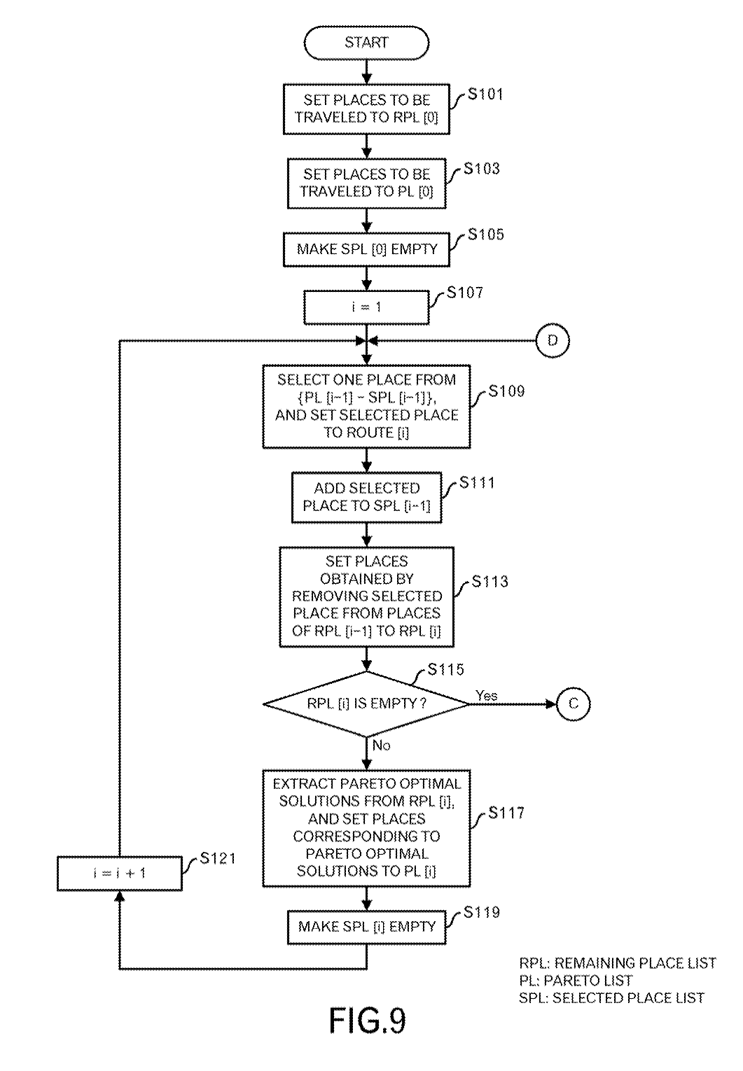

Next, processing contents of the information processing apparatus 100 will be explained by using FIGS. 9 to 11. In order to simplify the explanation, a case where the places A to D are traveled is considered, similarly to the first embodiment. Then, it is assumed that data as illustrated in FIG. 2 is stored in the first data storage unit 110. Furthermore, it is assumed that data as illustrated in FIG. 3 is stored in the second data storage unit 120.

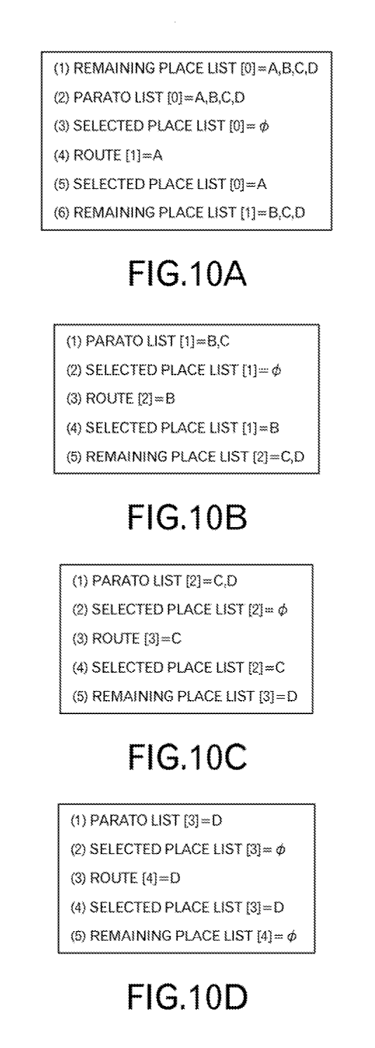

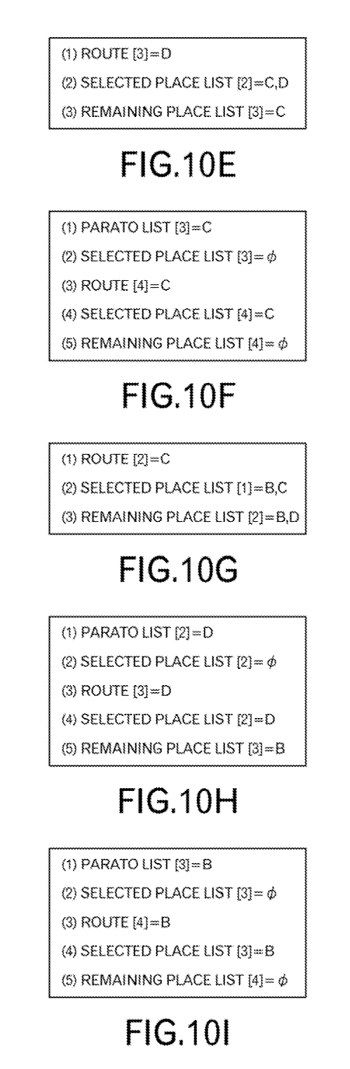

The traveling route candidate generator 130 sets places to be traveled, which are registered in the first data storage unit 110 and the second data storage unit 120, to a remaining place list [0], which is an array (FIG. 9: step S101). In the above example, as illustrated in (1) of FIG. 10A, the remaining place list [0]=A, B, C and D. In addition, the traveling route candidate generator 130 sets places to be traveled, which are registered in the first data storage unit 110 and the second data storage unit 120, to a Pareto list [0], which is an array (step S103). As illustrated in (2) of FIG. 10A, the Pareto list [0]=A, B, C and D. Incidentally, when the start point among the places to be traveled has been determined, the start point is set to the Pareto list [0]. Moreover, the traveling route candidate generator 130 makes a selected place list [0], which is an array, empty (step S105). As illustrated in (3) of FIG. 10A, the selected place list [0]=φ is set. Then, the traveling route candidate generator 130 initializes a counter to “1” (step S107).

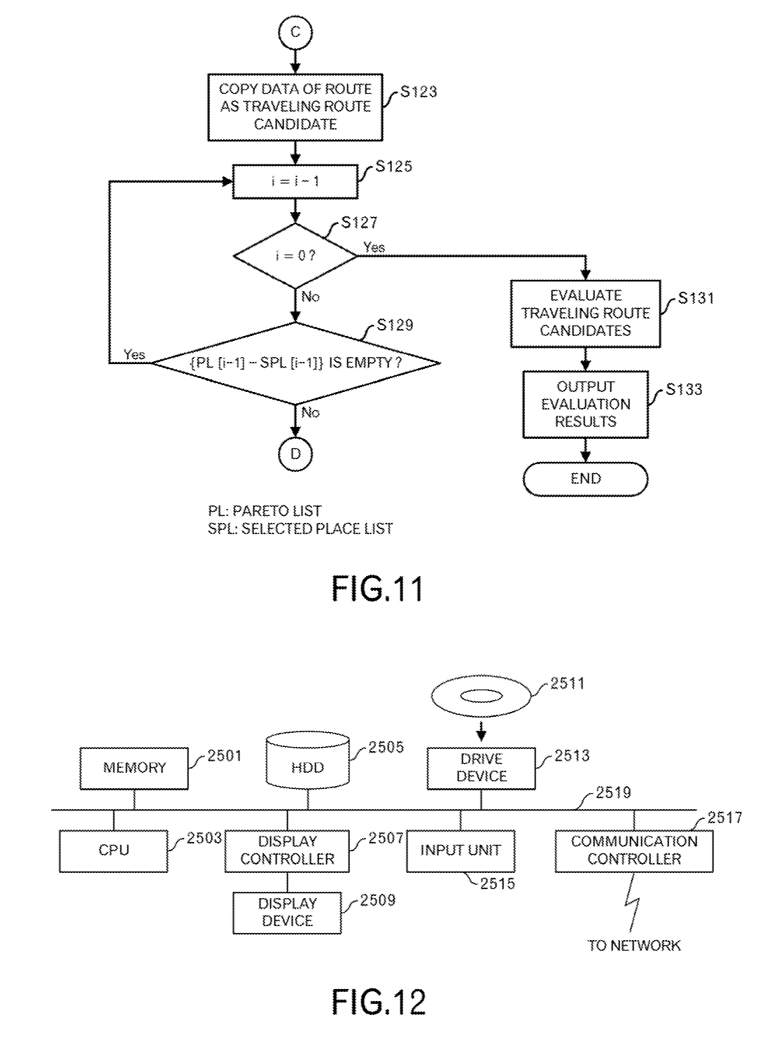

After that, the traveling route candidate generator 130 selects one place from among elements (represented as {Pareto list [i−1]−selected place list [i−1]}) obtained by removing elements of the selected place list [i−1] from elements of the Pareto list [i−1], and sets the selected place to a route [i], which is an array (step S109). The selection at this step may be carried out in any method. Because the selected place list [0] is empty, for example, the place A is selected from the Pareto list [0], and the route [1]=A is set as illustrated in (4) of FIG. 10A. Moreover, the traveling route candidate generator 130 sets the selected place to the selected place list [0] (step S111). When the place A is selected, the selected place list [0]=A is obtained as illustrated in (5) of FIG. 10A. Furthermore, the traveling route candidate generator 130 sets elements obtained by removing the selected place from the remaining place list [i−1] to the remaining place list [i] (step S113). When the place A is selected, the place A is removed from the remaining place list [0]=A, B, C and D, and the remaining place list [1]=B, C and D is set as illustrated in (6) of FIG. 10A. Then, the traveling route candidate generator 130 determines whether or not the remaining place list [i] becomes empty (step S115). When the remaining place list [i] becomes empty, the processing shifts to the processing in FIG. 11 through a terminal C.

On the other hand, when the remaining place list [i] is not empty, the traveling route candidate generator 130 identifies points in the cost space, which correspond to the places included in the remaining place list [i], extracts the Pareto optimal solutions from among these points, and sets the places corresponding to the extracted Pareto optimal solutions to the Pareto list [i] (step S117). This step is similar to the step S15 in the first embodiment.

Specifically, in a state of (6) in FIG. 10A, the remaining place list [1]=B, C and D. Then, the corresponding points on the plane (typically, space) that is mapped by the travel cost and the second cost, are identified. More specifically, when the travel cost value=10 (FIG. 2) from the place A, which is identified as being included in the route, to the place B and the second cost value=50 (FIG. 3) of the place B are read out from the first data storage unit 110 and the second data storage unit 120, a point X1 on the plane illustrated in FIG. 6A is identified. Similarly, when the travel cost value=30 (FIG. 2) from the place A to the place C and the second cost value of the place C=20 (FIG. 3) are read out from the first data storage unit 110 and the second data storage unit 120, a point X3 on the plane illustrated in FIG. 6A is identified. Furthermore, when the travel cost value=20 (FIG. 2) from the place A to the place D and the second cost value of the place D=50 (FIG. 3) are read out from the first data storage unit 110 and the second data storage unit 120, a point X2 on the plane illustrated in FIG. 6A is identified. In case of FIG. 6A, the points X3 and X1 are Pareto optimal solutions. Therefore, the place C corresponding to the point X3 and the place B corresponding to the point X1 are extracted, and as illustrated in (1) of FIG. 10B, the places C and B are set to the Pareto list [1].

After that, the traveling route candidate generator 130 makes the selected place list [i] empty (step S119). As illustrated in (2) of FIG. 10B, the selected place list [1]=φ is set. This is because the candidate of places to be traveled next is appropriately identified. Then, the traveling route candidate generator 130 increments i by “1” (step S121), and the processing returns to the step S109.

In the aforementioned example, the place B is selected from among the places obtained by removing the elements of the selected place list [1] from the elements of the Pareto list [1], and as illustrated in (3) of FIG. 10B, the route [2]=B is set (step S109). Furthermore, the selected place B is set to the selected place list [1] (step S111). Then, as illustrated in (4) of FIG. 10B, the selected place list [1]=B is obtained. Furthermore, the places obtained by removing the selected place B from the remaining place list [1] are set to the remaining place list [2] (step S113). Namely, as illustrated in (5) of FIG. 10B, the remaining place list [2]=C and D is obtained.

Because the remaining place list [2] is not empty, points in the cost space, which correspond to the places C and D included in the remaining place list [2], are identified, and the Pareto optimal solutions are extracted from those points (step S117).

In a state of (5) in FIG. 10B, the remaining place list [2]=C and D. Therefore, points on the plane mapped by the travel cost and the second cost, which correspond to them, are identified. Specifically, when the travel cost value=30 (FIG. 2) from the place B, which has been identified as being included in the route, to the place C, and the second cost value=20 (FIG. 3) of the place C are read out from the first data storage unit 110 and the second data storage unit 120, a point Y1 on the plane illustrated in FIG. 6B is identified. Moreover, when the travel cost value=15 (FIG. 2) from the place B to the place D and the second cost value=50 (FIG. 3) of the place D are read out from the first data storage unit 110 and the second data storage unit 120, a point Y2 on the plane illustrated in FIG. 6B is identified. Because it cannot be said that either of the points Y1 and Y2 is superior, they are Pareto optimal solutions. Therefore, the place C corresponding to the point Y1 and the place D corresponding to the point Y2 are extracted, they are set to the Pareto list [2] as illustrated in (1) of FIG. 10C. Moreover, as illustrated in (2) of FIG. 10C, the selected place list [2] is made empty (step S119). Here, i is incremented by “1” (step S121), and i=3 is obtained.

Then, the place C is selected from among the places obtained by removing the elements of the selected place list [2] from the elements of the Pareto list [2], and the route [3]=C is set as illustrated in (3) of FIG. 10C (step S109). Furthermore, the selected place C is set to the selected place list [2] (step S111). Then, as illustrated in (4) of FIG. 10C, the selected place list [2]=C. Moreover, places obtained by removing the selected place C from the remaining place list [2] are set to the remaining place list [3] (step S113). In other words, as illustrated in (5) of FIG. 10C, the remaining place list [3]=D is obtained.

Because the remaining place list [3] is not empty, a point in the cost space, which corresponds to the place D included in the remaining place list [3], is identified, and the Pareto optimal solution is extracted from the points (step S117). However, when only one place is included in the remaining place list [3], the point is designated as the Pareto optimal solution as it is. In other words, as illustrated in (1) of FIG. 10D, the Pareto list [3]=D is obtained. In addition, as illustrated in (2) of FIG. 10D, the selected place list [3] is made empty (step S119). Here, is incremented by “1” (step S121), and i=4 is obtained.

Then, the place D is selected from among the places obtained by removing the elements of the selected place list [3] from the elements of the Pareto list [3], and as illustrated in (3) of FIG. 10D, the route [4]=D is set (step S109). Furthermore, the selected place D is set to the selected place list [3] (step S111). Then, as illustrated in (4) of FIG. 10D, the selected place list [3]=D is obtained. Moreover, the places obtained by removing the selected place D from the remaining place list [3] are set to the remaining place list [4] (step S113). Namely, as illustrated in (5) of FIG. 10D, the remaining place list [4]=φ is obtained. By carrying out such a processing, because the remaining place list [4] becomes empty, the processing shifts to a processing of FIG. 11 through the terminal C.

In FIG. 11, the traveling route candidate generator 130 copies data of the route as the traveling route candidate, and stores the copied data of the route into the third data storage unit 140 (step S123). Thus, one traveling route candidate has been generated. In the aforementioned example, the traveling route candidate including the places A, B, C and D in this order is stored in the third data storage unit 140. The following processing is a processing to search other traveling route candidates.

Then, the traveling route candidate generator 130 decrements i by “1” (step S125), and determines whether or not becomes “0” (step S127). When i=0 is not satisfied, the traveling route candidate generator 130 determines whether or not a set (this is represented by {Pareto list [i−1]−selected place list [i−1]}) obtained by removing the elements of the selected place list [i−1] from the elements of the Pareto list [i−1] is empty (step S129). When the set is empty, the processing returns to the step S125. On the other hand, the processing returns to the step S109 of FIG. 9 through a terminal D.

In the aforementioned example, in case of i=3, {Pareto list [2]−selected place list [2]}=D as illustrated in (1) and (4) of FIG. 10C. Therefore, the processing returns to the step S109 of FIG. 9.

Then, the place D is selected from {Pareto list [2]-selected place list [2]}, and as illustrated in (1) of FIG. 10E, the route [3]=D is set (step S109). Furthermore, when the selected place D is added to the selected place list [2] (step S111), the selected place list [2]=C and D is obtained as illustrated in (2) of FIG. 10E. Moreover, the places obtained by removing the selected place D from the remaining place list [2] ((5) of FIG. 10B) are set to the remaining place list [3] (step S113). Namely, as illustrated in (3) of FIG. 10E, the remaining place list [3]=C is obtained.

Because the remaining place list [3] is not empty, the point in the cost space, which corresponds to the place C included in the remaining place list [3], is identified, and the Pareto optimal solution is extracted from these points (step S117). However, when only one place is included in the remaining place list [3], the place is designated as the Pareto optimal solution as it is. Namely, as illustrated in (1) of FIG. 10F, the Pareto list [3]=C is obtained. Furthermore, as illustrated in (2) of FIG. 10F, the selected place list [3] is made empty (step S119). Here, i is incremented by “1” (step S121), i=4 is obtained.

Then, the place C is selected from among {Pareto list [3]−selected place list [3]}, and as illustrated in (3) of FIG. 10F, the route [4]=C is set (step S109). Furthermore, the selected place C is added to the selected place list [4] (step S111). Then, as illustrated in (4) of FIG. 10F, the selected place list [4]=C is obtained. Moreover, the places obtained by removing the selected place C from the remaining place list [3] are set to the remaining place list [4] (step S113). Namely, as illustrated in (5) of FIG. 10F, the remaining place list [4]=φ is obtained. By carrying out such a processing, because the remaining place list [4] becomes empty, the processing shifts to the processing of FIG. 11 through the terminal C.

Then, at the step S123 of FIG. 11, the second traveling route candidate including the places A, B, D and C in this order is stored into the third data storage unit 140.

After that, in case of i=3, because {Pareto list [2]−selected place list [2]} is empty from (2) of FIG. 10E and (1) of FIG. 10C, i is decremented by “1” (step S125). In case of i=2, {Pareto list [1]−selected place list [1]}=C is obtained from (1) and (4) of FIG. 10B. Then, the processing returns to the step S109 of FIG. 9.

Then, the place C is selected from {Pareto list [1]−selected place list [1]}, and as illustrated in (1) of FIG. 10G, the route [2]=C is set (step S109). Furthermore, the selected place C is added to the selected place list [1] (step S111), and as illustrated in (2) of FIG. 10G, the selected place list [1]=B and C is obtained. Moreover, the places obtained by removing the selected place C from the remaining place list [1] ((6) of FIG. 10A) is set to the remaining place list [2] (step S113). Namely, as illustrated in (3) of FIG. 10G, the remaining place list [2]=B and D is obtained.

Because the remaining place list [2] is not empty, the points in the cost space, which correspond to the places B and D included in the remaining place list [2], are identified, and the Pareto optimal solutions are extracted from those points (step S117).

In a state of (3) in FIG. 10G, the remaining place list [2]=B and D. Therefore, the points on the plane mapped by the travel cost and the second cost and corresponding to the places are identified. Specifically, when the travel cost value=30 (FIG. 2) from the place C, which has been identified as being included in the route, to the place B and the second cost value=50 (FIG. 3) of the place B are read out from the first data storage unit 110 and the second data storage unit 120, the point Z1 on the plane illustrated in FIG. 6C is identified. Moreover, when the travel cost value=15 (FIG. 2) from the place C to the place D and the second cost value=50 (FIG. 3) of the place D are read out from the first data storage unit 110 and the second data storage unit 120, the point Z2 on the plane illustrated in FIG. 6C is identified. Because the travel cost value of the point Z2 is less, the point Z2 is the Pareto optimal solution. Therefore, the place D corresponding to the point Z2 is extracted, and as illustrated in (1) of FIG. 10H, the place D is set to the Pareto list [2]. Furthermore, as illustrated in (2) of FIG. 10H, the selected place list [2] is made empty (step S119). Here, i is incremented by “1” (step S121), and i=3 is obtained.

Then, the place D is selected from {Pareto list [2]-selected place list [2]}, and as illustrated in (3) of FIG. 10H, the route [3]=D is set (step S109). Furthermore, as illustrated in (4) of FIG. 10H, the selected place D is added to the selected place list [2] (step S111). Moreover, the places obtained by removing the selected place D from the remaining place list [2] ((3) in FIG. 10G) are set to the remaining place list [3] (step S113). Namely, as illustrated in (5) of FIG. 10H, the remaining place list [3]=B is obtained.

Because the remaining place list [3] is not empty, the point in the cost space, which corresponds to the place B included in the remaining place list [3], is identified, and the Pareto optimal solution is extracted from the points (step S117). However, when only one place is included in the remaining place list [3], the place is designated as the Pareto optimal solution. Namely, as illustrated in (1) of FIG. 10I, the Pareto list [3]=B is obtained. Furthermore, as illustrated in (2) of FIG. 10I, the selected place list [3] is made empty (step S119). Here, i is incremented by “1” (step S121), and i=4 is obtained.

Then, the place B is selected from {Pareto list [3]-selected place list [3]}, and as illustrated in (3) of FIG. 10I, the route [4]=B is set (step S109). Furthermore, when the selected place B is added to the selected place list [3] (step S111), as illustrated in (4) of FIG. 10I, the selected place list [3]=B is obtained. Moreover, the places obtained by removing the selected place C from the remaining place list [3] is set to the remaining place list [4] (step S113). In other words, as illustrated in (5) of FIG. 10I, the remaining place list [4]=φ is obtained. By carrying out such a processing, the remaining place list [4] is empty. Therefore, the processing shifts to the processing in FIG. 11 through the terminal C.

Then, at the step S123 of FIG. 11, the third traveling route candidate including the places A, C, D and B in this order is stored in the third data storage unit 140. By carrying out such a processing, {Pareto list [1]−selected place list [1]} becomes empty. Incidentally, because {Pareto list [0]−selected place list [0]} includes the places B, C and D, a processing to exchange the start point is carried out. When the start point is fixed to the place A, the generation of the traveling route candidates is completed.

Returning to the explanation of FIG. 11, the traveling route selector 150 evaluates the traveling route candidates stored in the third data storage unit 140, and identifies the traveling route candidate whose evaluation value is the greatest (step S131). For example, the travel cost value stored in the first data storage unit 110 and other values (e.g. priority degree or the like) of each place, which are stored in the second data storage unit 120, are combined to calculate the evaluation value of each traveling route candidate. Any evaluation function may be used.

After that, the traveling route selector 150 outputs the evaluation results to the display device or other computers (step S133). The traveling route candidates may be outputted as they are.

By carrying out such a processing, a processing to trace the Pareto optimal solutions is carried out. Therefore, it is possible to obtain the traveling route candidates including at least traveling routes obtained by the nearest neighbor method. However, because the Pareto optimal solutions are traced, it is possible to obtain the traveling route candidates better than the routes obtained by the nearest neighbor method. Moreover, because the destination places are narrowed by the Pareto optimal solutions, the processing speed is higher than that of the round-robin method.

Incidentally, the processing to extract all of the Pareto optimal solutions is carried out at the step S117. However, in case of weighting the travel cost, the Pareto optimal solutions whose travel cost is less than the threshold may be preferentially extracted.

Although the embodiments of this technique were explained, this technique is not limited to those embodiments. For example, the functional block diagram does not always correspond to the actual program module configuration. Moreover, as for the processing flow, as long as the processing results do not change, an order of the steps may be exchanged or the steps may be executed in parallel.

Furthermore, in the aforementioned explanation, one computer is used to execute the aforementioned processing. However, plural computers may be used to execute the same processing. Moreover, such a processing may be executed by a server connected to a network in response to a request from a terminal apparatus connected to the network, and the processing result may be sent back to the terminal apparatus.

In addition, the aforementioned information processing apparatus 10 and 100 are computer devices as illustrated in FIG. 12. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as illustrated in FIG. 12. An operating system (OS) and an application program for carrying out the foregoing processing in the embodiment are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

The aforementioned embodiments are summarized as follows:

An information processing method relating to the embodiments includes: (A) first identifying, for each candidate place of a second place that will be traveled subsequently to a first place whose traveling order has been determined among a plurality of places and for which traveling order is not determined among the plurality of places, a point in a space mapped by a travel cost and one or plural costs, by reading out a travel cost value between the first place and the candidate place from a first storage unit storing a travel cost value for each combination of two places among the plurality of places, and reading one or plural cost values of the candidate place from a second data storage unit storing one or plural cost values for each of the plurality of places; (B) extracting one or plural candidate places corresponding to Pareto solutions in the space; (C) second identifying the second place from the one or plural extracted candidate places; and (D) generating traveling route candidates for the plurality of places by repeating the first identifying, the extracting and the second identifying.

Thus, by narrowing the next traveling place with the Pareto solutions, it becomes possible to generate the traveling route candidates at high-speed. Moreover, it is possible to obtain preferable solutions in view of the cost including the travel cost, because the Pareto solutions are used.

Incidentally, the information processing method relating to the embodiment may further include: upon detecting that plural candidate places were extracted, third identifying a third place from among the plural candidate places other than the second place; and generating another traveling route candidate including a partial route up to the first place and a partial route from the third place. When plural Pareto solutions exist, it becomes possible to generate traveling route candidates for the Pareto solutions, comprehensively.

Furthermore, the aforementioned generating may include: upon detecting that one candidate place of the second place is extracted, setting the candidate place as a final traveling place. In such a case, the processing can be simplified.

Furthermore, the aforementioned extracting may include: preferentially extracting a Pareto optimal solution whose travel cost is less than a threshold. When the travel cost is seriously considered, such a processing may be carried out.

Furthermore, the information processing method relating to the embodiments may further include: identifying a traveling route to be adopted from among the generated traveling route candidates. For example, when the traveling route whose evaluation is the highest is identified, it becomes possible to obtain the most preferable traveling route.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable, non-transitory storage medium storing a program for causing a computer to execute a procedure, the procedure comprising:
first identifying, for each candidate place of a second place that will be traveled subsequently to a first place whose traveling order has been determined among a plurality of places and for which traveling order is not determined among the plurality of places, a point in a space mapped by a travel cost and one or plural costs, by reading out a travel cost value between the first place and the candidate place from a first storage unit storing a travel cost value for each combination of two places among the plurality of places, and reading one or plural cost values of the candidate place from a second data storage unit storing one or plural cost values for each of the plurality of places;
extracting one or plural candidate places corresponding to Pareto solutions in the space;
second identifying the second place from the one or plural extracted candidate places; and
generating traveling route candidates for the plurality of places by repeating the first identifying, the extracting and the second identifying.

2. The computer-readable, non-transitory storage medium as set forth in claim 1, wherein the procedure further comprises:
upon detecting that plural candidate places were extracted, third identifying a third place from among the plural candidate places other than the second place; and
generating another traveling route candidate including a partial route up to the first place and a partial route from the third place.

3. The computer-readable, non-transitory storage medium as set forth in claim 1, wherein the generating comprises:
upon detecting that one candidate place of the second place is extracted, setting the candidate place as a final traveling place.

4. The computer-readable, non-transitory storage medium as set forth in claim 1, wherein the extracting comprises:
preferentially extracting a Pareto optimal solution whose travel cost is less than a threshold.

5. The computer-readable, non-transitory storage medium as set forth in claim 1, wherein the procedure further comprises:
identifying a traveling route to be adopted from among the generated traveling route candidates.

6. An information processing method, comprising:
first identifying, by using a computer, for each candidate place of a second place that will be traveled subsequently to a first place whose traveling order has been determined among a plurality of places and for which traveling order is not determined among the plurality of places, a point in a space mapped by a travel cost and one or plural costs, by reading out a travel cost value between the first place and the candidate place from a first storage unit storing a travel cost value for each combination of two places among the plurality of places, and reading one or plural cost values of the candidate place from a second data storage unit storing one or plural cost values for each of the plurality of places;
extracting, by using the computer, one or plural candidate places corresponding to Pareto solutions in the space;
second identifying, by using the computer, the second place from the one or plural extracted candidate places; and
generating traveling, by using the computer, route candidates for the plurality of places by repeating the first identifying, the extracting and the second identifying.

7. The information processing method as set forth in claim 6, further comprising:
upon detecting that plural candidate places were extracted, third identifying a third place from among the plural candidate places other than the second place; and
generating another traveling route candidate including a partial route up to the first place and a partial route from the third place.

8. The information processing method as set forth in claim 6, wherein the generating comprises:
upon detecting that one candidate place of the second place is extracted, setting the candidate place as a final traveling place.

9. The information processing method as set forth in claim 6, wherein the extracting comprises:
preferentially extracting a Pareto optimal solution whose travel cost is less than a threshold.

10. The information processing method as set forth in claim 6, wherein the procedure further comprises:
identifying a traveling route to be adopted from among the generated traveling route candidates.

11. An information processing apparatus, comprising:
a memory;
a processor using the memory and configured to execute a procedure, the procedure comprising:
first identifying, for each candidate place of a second place that will be traveled subsequently to a first place whose traveling order has been determined among a plurality of places and for which traveling order is not determined among the plurality of places, a point in a space mapped by a travel cost and one or plural costs, by reading out a travel cost value between the first place and the candidate place from a first storage unit storing a travel cost value for each combination of two places among the plurality of places, and reading one or plural cost values of the candidate place from a second data storage unit storing one or plural cost values for each of the plurality of places;
extracting one or plural candidate places corresponding to Pareto solutions in the space;
second identifying the second place from the one or plural extracted candidate places; and
generating traveling route candidates for the plurality of places by repeating the first identifying, the extracting and the second identifying.

12. The information processing apparatus as set forth in claim 11, wherein the procedure further comprises:
upon detecting that plural candidate places were extracted, third identifying a third place from among the plural candidate places other than the second place; and
generating another traveling route candidate including a partial route up to the first place and a partial route from the third place.

13. The information processing apparatus as set forth in claim 11, wherein the generating comprises:
upon detecting that one candidate place of the second place is extracted, setting the candidate place as a final traveling place.

14. The information processing apparatus as set forth in claim 11, wherein the extracting comprises:
preferentially extracting a Pareto optimal solution whose travel cost is less than a threshold.

15. The information processing apparatus as set forth in claim 11, wherein the procedure further comprises:
identifying a traveling route to be adopted from among the generated traveling route candidates.
